(19) United States
(12) Patent Application Publication
(10) Pub. No.: US 2008/0216345 A1
(43) Pub. Date: Sep. 11, 2008

(54) Device for dehydrating food

(76) Inventor: Michael J. Barkfelt, Medina, OH (US)

Correspondence Address: FORREST L. COLLINS;COLLINS, CARY & ASSOCIATES, POST OFFICE BOX 41040, BRECKSVILLE, OH, 44141-0040, US

(21) Appl. No.: 11/715,752

(22) Filed: Mar. 8, 2007

(51) Int. Cl. F26B 25/06

(52) U.S. Cl. 34/235

(57) ABSTRACT

The invention describes a device for dehydrating food such as fruits, vegetables, or meat products such as jerky. The device is adapted to permit opening form either screened side. An advantage to the present invention is the use of a cable that is resistant to stretching while avoiding the use of rods that bend in the center.

### BACKGROUND OF THE INVENTION

1. Field of the Invention

The invention relates to The purpose of this invention is to

2. Description of the Art Practices

U.S. Pat. No. 4,221,059 issued Sep. 9, 1980 to Everitt describes a box-shaped housing having side and end walls together with a back wall, leaving an opening at its front. A cover of material transparent to sunlight removably closes the front. Inside the device of Everitt are a plurality of shelves mounted so as to be tilted at an angle with respect to the end walls. The housing is supported in a stationary position with its back wall tilted backwardly from the top so as to orient the removable shelves substantially in a horizontal position. A plurality of apertures in the housing enable air flow upwardly therethrough.

U.S. Pat. 5,115,566 issued to Zeitlin on May 26, 1992 recites an electrically actuated food and liquid fanning device that may be removably secured to a food or liquid holding utensil, container, or the like, which will generate a draft in a desired direction that is of material assistance in cooling the food or liquid held by the utensil, container, or other food or liquid holding device.

Furman, et al., in U.S. Pat No. 5,139,012 issued Aug. 18, 1992 posits a fireplace heat exchanger having input means that is directly connected to a blower assembly, air to be heated is drawn in by the blower assembly and forced directly through the input means into a heat reservoir that is suspended directly above or within the flame of the fireplace. The air is heated within the heat reservoir and then forced through an output means that includes a plurality of discharge ports through which the heated air is dispersed into a room. A manifold covers those portions of the input and output means that are outside the fireplace. That portion of the manifold that covers the output means includes a corresponding plurality of discharge ports through which the heated air is dispersed. The input and output means slidably fit within the input and output riser tubes so the heat exchanger can be adjusted for fireplaces of various depths. The heat exchanger can be used with fireplaces having a frame with closable doors, wire mesh curtains, or the like.

U.S. Pat. No. 6,019,099 to Shimek, et al., issued Feb. 1, 2000 describes a high efficiency gas fireplace unit having a heat exchanger is located in a room in which the heat from the gas fireplace is not wanted. An air duct is connected to the heat exchanger and has a termination point in a room or area remote from the gas fireplace unit. During a heat dump or heat transfer mode of operation, an induced draft fan in an air duct is activated by a remote switch thrown to cause room air to be sucked through the heat exchanger and passed through the air duct and dumped in a remote area so that the fireplace heating effect is nullified or neutralized allowing the fireplace to be operated with or without an air conditioning system.

U.S. Pat. No. 6,666,206 issued Dec. 23, 2003 to Myrick discloses fireplace insert used in a fireplace to surround a heat source, including an arcuate conduit that is able to substantially surround the heat source on multiple sides. The conduit includes an inhaling end and an exhaling end, and divided into an intake channel, a base channel, and an outtake channel. The intake channel includes a proximal end and a distal end; the base channel includes a first end and a second end; and the outtake channel includes a proximal end and a distal end. The proximal end of the intake channel is connected to the first end of the base channel, and the proximal end of the outtake channel is connected to the second end of the base channel for the conduit to be in a significantly U-shape. A fan is positioned near the distal end of the intake channel and is able to force heated air through the conduit.

Lyons, et al., in U.S. Pat. No. 6,908,039 issued on Jun. 21, 2005 sets out a heat exchange system and method for heating outside air provided to a structure are disclosed. The system uses and recovers heat from waste products that are being exhausted from the structure. A heated products source generates heated waste products as a result of combustion. An exhaust duct passes the heated waste products through a heat exchanger before exhaustion from the structure. An intake duct that supplies fresh outside air to the structure also passes through the heat exchanger. The heat exchanger couples the exhaust duct and the intake duct and transfers otherwise unused heat from the waste products to the outside air to increase the overall efficiency of the heated product source.

U.S. Patent Application 20050257787 authored by Dolton Edward Gerard III and published Nov. 24, 2005 describes a filtered aromatic fireplace heat recovery system may include an intake blower that intakes air from a room; a heat exchanging means that receives and heats air from the intake blower; and an output blower that evenly distributes the heated air into a room. In some embodiments, the system may include a filter means located within the intake blower and/or the output blower that filters pollutants, particulates, offensive odors, and toxins given off by the fuel burned within the fireplace. The system may also include a fragrance dispensing means located within the intake blower and/or the output blower to distribute a desired fragrance within a room.

To the extent that the foregoing references are relevant to the present invention, they are herein specifically incorporated by reference. Certain portions of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### SUMMARY OF THE INVENTION

The invention is a food dehydrating device comprising:

a food dehydrating device box structure;

said food dehydrating device box structure having a food dehydrating device top region;

a food dehydrating device first side piece connected with said food dehydrating device top region;

a food dehydrating device bottom region connected with said food dehydrating device first side piece;

a food dehydrating device second side piece connected with said food dehydrating device top region and connected with said food dehydrating device bottom region;

a food dehydrating device rear screened section connected with said food dehydrating device top region;

a food dehydrating device endless cable first opening located in said food dehydrating device first side piece;

a food dehydrating device endless cable second opening located in said food dehydrating device first side piece; and,

a food dehydrating device endless cable extending through said food dehydrating device endless cable first opening and said food dehydrating device endless cable second opening.

The invention also comprises a food dehydrating device having:

a food dehydrating device box structure;

said food dehydrating device box structure having a food dehydrating device top region;

a food dehydrating device first side piece connected with said food dehydrating device top region;

a food dehydrating device bottom region connected with said food dehydrating device first side piece;

a food dehydrating device second side piece connected with said food dehydrating device bottom region and connected with said food dehydrating device top region;

a food dehydrating device rear screened section connected with said food dehydrating device top region;

a food dehydrating device front screened section connected with said food dehydrating device top region;

a food dehydrating device endless cable first opening located in said food dehydrating device first side piece;

a food dehydrating device endless cable first opening located in said food dehydrating device second side piece;

a food dehydrating device endless cable second opening located in said food dehydrating device first side piece;

a food dehydrating device endless cable opening located in said food dehydrating device second side piece;

a food dehydrating device endless cable extending through said food dehydrating device endless cable first openings, and said food dehydrating device endless cable second openings;

a food dehydrating device endless cable extension extending from said food dehydrating device endless cable;

a food dehydrating device endless cable attachment attached to said food dehydrating device endless cable extension; and,

a food dehydrating device endless cable extension securing mechanism located on said food dehydrating device first side piece, and for when in use, said food dehydrating device endless cable extension securing mechanism secures said dehydrating device endless cable attachment to said food dehydrating device first side piece.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a perspective view of the device of the present invention;

FIG. 2 is a first side exterior view of the present invention according to FIG. 1;

FIG. 3 is a second side exterior view of the present invention according to FIG. 1;

FIG. 4 is a view of a retaining pin for use in the device of present invention;

FIG. 5 is a plan view of food rack for use in the present invention;

FIG. 6 is a view of a skewer for use with the device of present invention; and,

FIG. 7 is a plan exterior view of the present invention according to FIG. 1;

With more particular reference to the drawings the following is set forth.

### DETAILED DESCRIPTION OF THE INVENTION

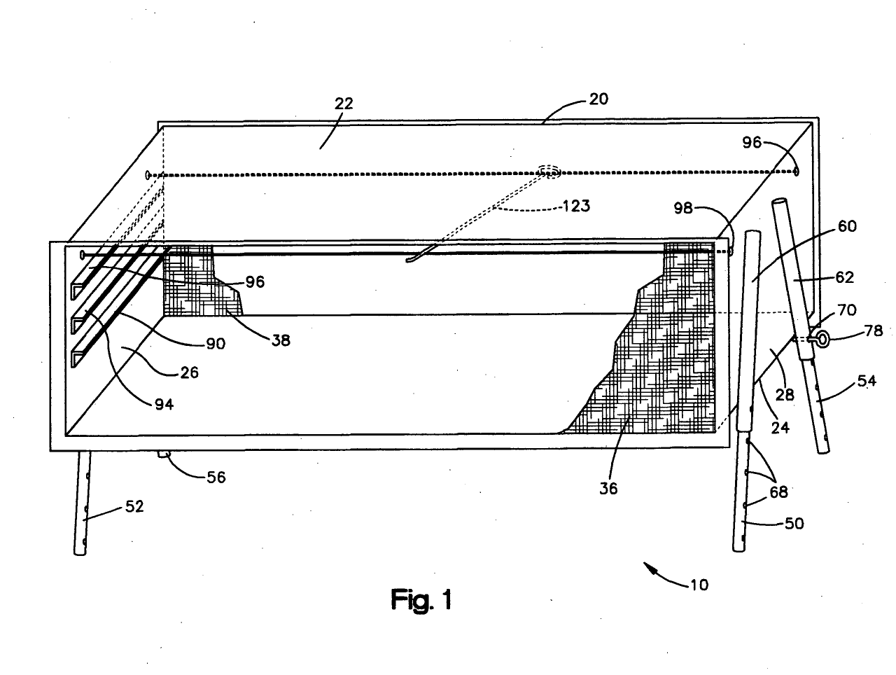

As best seen in FIG. 1, is a food dehydrating device 10 according to the present invention. The food dehydrating device 10 is a food dehydrating device box structure 20. The food dehydrating device box structure 20 has a food dehydrating device top region 22. The food dehydrating device box structure 20 has a food dehydrating device bottom region 24.

The food dehydrating device box structure 20 further has a food dehydrating device first side piece 26. The generally food dehydrating device box structure 20 also has a food dehydrating device second side piece 28.

A feature of all of the food dehydrating device box structure 20 is a food dehydrating device rear screened section 36. A food dehydrating device front screened section 38 is also combined with the food dehydrating device box structure 20.

Conveniently, a food dehydrating device hinge 40 secures the food dehydrating device front screened section 38 to the food dehydrating device top region 22. A food dehydrating device flange 42 extends along the food dehydrating device top region 22 proximate to the food dehydrating device hinge 40.

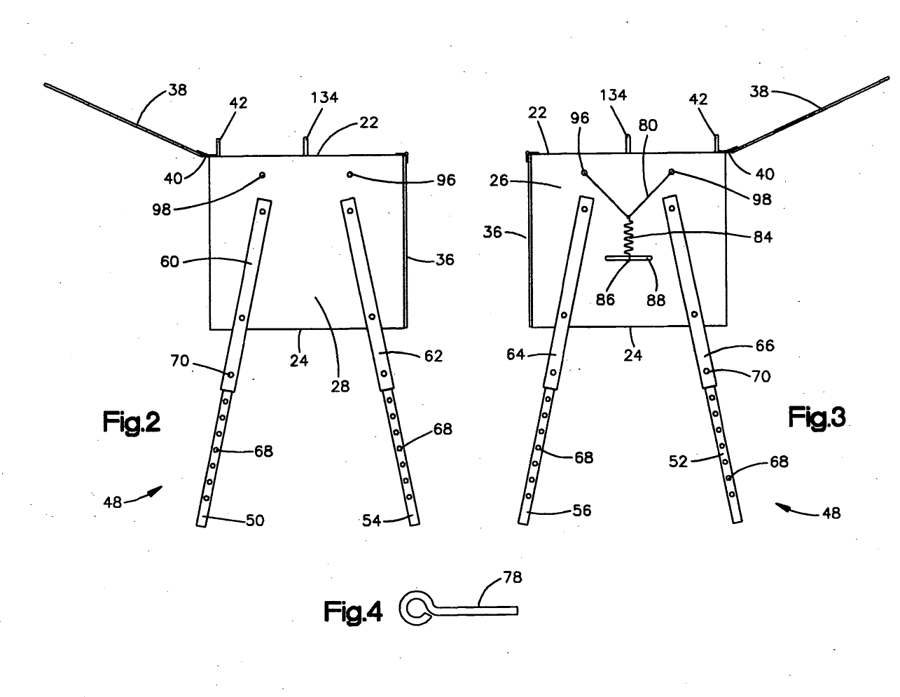

As best seen in FIG. 2 and FIG. 3 is a plurality of food dehydrating device legs 48 associated with the food dehydrating device box structure 20. The plurality of food dehydrating device legs 48 are the food dehydrating device first lower leg 50, the food dehydrating device second lower leg 52, the food dehydrating device third lower leg 54, and the food dehydrating device fourth lower leg 56. The food dehydrating device first lower leg 50, the food dehydrating device second lower leg 52, the food dehydrating device third lower leg 54, and the food dehydrating device fourth lower leg 56, are in the normal practice cylindrical and may be hollow.

The plurality of food dehydrating device legs 48 are also typically comprised of a food dehydrating device first upper leg 60, a food dehydrating device second upper leg 62, a food dehydrating device third upper leg 64, and a food dehydrating device fourth upper leg 66. Conveniently, the food dehydrating device first upper leg 60, food dehydrating device second upper leg 62, food dehydrating device third upper leg 64, and food dehydrating device fourth upper leg 66 are cylindrical and hollow. The food dehydrating device first upper leg 60, the food dehydrating device second upper leg 62, the food dehydrating device third upper leg 64, and the food dehydrating device fourth upper leg 66 are attached to the food dehydrating device box structure 20 on the food dehydrating device bottom region 24.

A plurality of food dehydrating device lower leg openings 68 are located in the food dehydrating device first lower leg 50. A plurality of food dehydrating device lower leg openings 68 are located in the food dehydrating device second lower leg 52.

A plurality of food dehydrating device lower leg openings 68 are located in the food dehydrating device third lower leg 54. A plurality of food dehydrating device lower leg openings 68 are located in the food dehydrating device fourth lower leg 56.

The plurality of food dehydrating device lower leg openings 68 conveniently extend through the cylinder walls of the food dehydrating device first lower leg 50, the food dehydrating device second lower leg 52, the food dehydrating device third lower leg 54, and the food dehydrating device fourth lower leg 56. The plurality of food dehydrating device lower leg openings 68 extend diametrically across the cylinder of the food dehydrating device first lower leg 50, the food dehydrating device second lower leg 52, the food dehydrating device third lower leg 54, and food dehydrating device fourth lower leg 56.

The dimensions of the plurality of food dehydrating device lower leg openings 68 are such that the plurality of food dehydrating device lower leg openings 68 does not structurally weaken the food dehydrating device first lower leg 50, the food dehydrating device second lower leg 52, the food dehydrating device third lower leg 54, and the food dehydrating device fourth lower leg 56.

A plurality of food dehydrating device upper leg openings 70 is located in the food dehydrating device first upper leg 60. A plurality of food dehydrating device upper leg openings 70 is located in the food dehydrating device second upper leg 62.

A plurality of food dehydrating device upper leg openings 70 is located in the food dehydrating device third upper leg 64. A plurality of food dehydrating device upper leg openings 70 is located in the food dehydrating device fourth upper leg 66.

The plurality of food dehydrating device upper leg openings 70 conveniently extend through the cylinder walls of the food dehydrating device first upper leg 60, the food dehydrating device second upper leg 62, the food dehydrating device third upper leg 64, and the plurality of food dehydrating device upper leg openings 70. The plurality of food dehydrating device upper leg openings 70 extend diametrically across the cylinder of the food dehydrating device first upper leg 60, the food dehydrating device second upper leg 62, the food dehydrating device third upper leg 64, and food dehydrating device fourth upper leg 66.

The dimensions of the plurality of food dehydrating device upper leg openings 70 are such that the plurality of food dehydrating device upper leg openings 70 does not structurally weaken the food dehydrating device first upper leg 60, the food dehydrating device second upper leg 62, the food dehydrating device third upper leg 64, and the food dehydrating device fourth upper leg 66.

A plurality of food dehydrating device retaining pins 78 may be used to adjust the height of the food dehydrating device 10 by judicious selection of the length of each of the food dehydrating device legs 48. For example, the food dehydrating device 10 may be placed in front of a fireplace (not shown) that has a shelf extending from the fireplace in the region of the floor.

In such a case the food dehydrating device retaining pins 78 are inserted through the food dehydrating device upper leg openings 70 into the food dehydrating device lower leg openings 68. If desired the plurality of food dehydrating device retaining pins 78 may be of the locking type such as a cotter pin.

In such a situation it may be necessary to adjust to the length of the rear legs 48 by inserting the food dehydrating device second lower leg 52 into the food dehydrating device second upper leg 62 and inserting the food dehydrating device fourth lower leg 56 into the food dehydrating device fourth upper leg 66 so the rear legs 48 are shorter than the front legs 48 thereby allowing the food dehydrating device 10 to be positioned in a level manner and closer to the heat source.

The food dehydrating device box structure 20 is equipped with a food dehydrating device endless cable 80. The food dehydrating device endless cable 80 extends through a food dehydrating device endless cable opening 96 on the food dehydrating device first side piece 26.

The food dehydrating device endless cable 80 traverses the interior length of the food dehydrating device box structure 20 to the second food dehydrating device endless cable opening 96 located on the food dehydrating device second side piece 28. The food dehydrating device endless cable 80 wraps around the outer side of the food dehydrating device second side piece 28. The food dehydrating device endless cable 80 then enters the food dehydrating device endless cable opening 98 on the food dehydrating device second side piece 28 and traverses the interior length of the food dehydrating device box structure 20.

The food dehydrating device endless cable 80 then exits the food dehydrating device box structure 20 through a food dehydrating device endless cable opening 98 on the food dehydrating device first side piece 26. The dehydrating device endless cable 80 is then affixed end to end to form a continuous loop.

A food dehydrating device endless cable extension 84 is connected with the food dehydrating device endless cable 80 at the midpoint of the food dehydrating device endless cable extension 80 on the outer surface of the food dehydrating device first side piece 26. A food dehydrating device endless cable attachment 86 is connected with the opposite terminus of the food dehydrating device endless cable extension 84 from the food dehydrating device endless cable extension 80. For convenience, the food dehydrating device endless cable attachment 86 is a hook.

A food dehydrating device endless cable extension securing mechanism 88 is formed on the food dehydrating device first side piece 26 such as by punching out a portion of the metal from which the food dehydrating device first side piece 26 is formed. The food dehydrating device endless cable extension securing mechanism 88 may also be a handle like structure screwed onto the food dehydrating device first side piece 26.

The food dehydrating device endless cable extension 84 is of a sufficient length for the food dehydrating device endless cable attachment 86 to extend to the food dehydrating device endless cable extension securing mechanism 88. The food dehydrating device endless cable 80 is maintained in a relatively taut condition in the food dehydrating device box structure 20 by the food dehydrating device endless cable extension 84 and the food dehydrating device endless cable attachment 86 terminating in the food dehydrating device endless cable extension securing mechanism 88.

Turning again to FIG. 1, there is shown on the interior of the food dehydrating device second side piece 28 a food dehydrating device shelf 90, a food dehydrating device shelf 94, and a food dehydrating device shelf 96. A similar arrangement of a food dehydrating device shelf 90, a food dehydrating device shelf 94, and a food dehydrating device shelf are located on the interior wall of the food dehydrating device first side piece 26.

The arrangement of the sets of the food dehydrating device shelf 90, food dehydrating device shelf 94, and food dehydrating device endless cable opening 96 will permit several racks to be placed horizontally between the perspective food dehydrating device shelf 90, food dehydrating device shelf 94, and food dehydrating device endless cable opening 96.

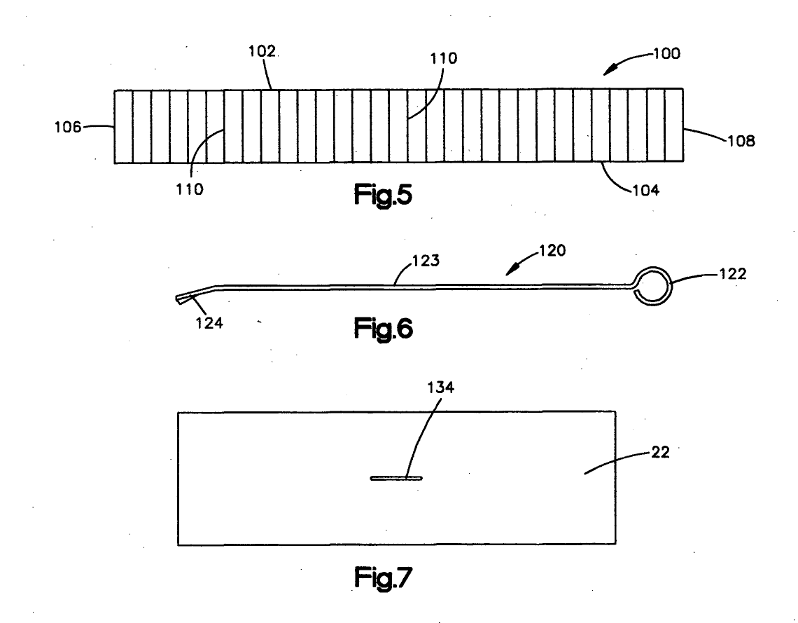

Turning now to FIG. 5, there is shown a food dehydrating device rack 100 suitable for placement between the food dehydrating device shelf 90, food dehydrating device shelf 94, and food dehydrating device endless cable opening 96. The food dehydrating device rack 100 has a food dehydrating device rack first long side 102 located in a parallel relationship to a food dehydrating device rack second long side 104.

The food dehydrating device rack 100 has a food dehydrating device rack first end 106 located in a parallel relationship with a food dehydrating device rack second end 108. The food dehydrating device rack first long side 102 joins the food dehydrating device rack first end 106 at a right angle. The food dehydrating device rack first end 106 joins the food dehydrating device rack second long side 104 at a right angle.

The food dehydrating device rack second long side 104 joins the food dehydrating device rack second end 108 at a right angle. The food dehydrating device rack second end 108 joins the food dehydrating device rack first long side 102 at a right angle.

A plurality of food dehydrating device rack supports 110 extend between the food dehydrating device rack first long side 102 and the food dehydrating device rack second long side 104. The plurality of food dehydrating device rack supports 110 are in a parallel relationship to the food dehydrating device rack first end 106 and the food dehydrating device rack second end 108.

The manner of joining the food dehydrating device rack first long side 102, the food dehydrating device rack first end 106, the food dehydrating device rack second long side 104, the food dehydrating device rack second end 108, and the plurality of food dehydrating device rack supports 110 may be by stamping or welding the individual pieces together.

As best seen in a FIG. 6, is a food dehydrating device skewer 120. The food dehydrating device skewer 120 has a food dehydrating device skewer eyelet 122 at one end thereof. A food dehydrating device skewer cylindrical region 123 extends from the food dehydrating device skewer eyelet 122. A food dehydrating device skewer curved end 124 extends from the opposite end of the food dehydrating device skewer cylindrical region 123 from the food dehydrating device skewer eyelet 122.

As best seen in FIG. 7, the food dehydrating device top region 22 has a food dehydrating device top handle 134. The food dehydrating device top handle 134 permits food dehydrating device 10 to be carried or positioned conveniently.

In practice, the food dehydrating device top region 22 and the food dehydrating device bottom region 24 may formed of the same material, such as aluminum and may be identical. In a similar fashion the food dehydrating device first side piece 26 and the food dehydrating device second side piece 28 may formed of the same material, such as aluminum and may be identical. The food dehydrating device rear screened section 36 and the food dehydrating device front screened section 38 may also be identical in nature and function if desired.

In use, a food item to be dehydrated may be placed on the food dehydrating device endless cable 80 which are located between the food dehydrating device shelf 90 on the food dehydrating device first side piece 26 and the food dehydrating device shelf 90 on the food dehydrating device second side piece 28.

The food dehydrating device 10 is then located such that the food dehydrating device rear screened section 36 is positioned close to a fireplace (not shown). The food items to be dehydrated are placed on the food dehydrating device rack 100.

The food dehydrating device front screened section 38 is opened. The food dehydrating device front screened section 38 is raised to a point such that the food dehydrating device front screened section 38 rests on the food dehydrating device flange 42.

The food dehydrating device rack 100 with the food items to be dehydrated is then inserted through the food dehydrating device front screened section 38. The food dehydrating device front screened section 38 is then closed to avoid inadvertent contact with the food item on the food dehydrating device rack 100 while the food items are dehydrating.

Alternatively, a food item may be placed on the food dehydrating device skewer 120 in the fashion of shishkebab. The food dehydrating device skewer 120 is then placed across the parallel portions of the food dehydrating device endless cable 80 within the food dehydrating device box structure 20. It is preferred that the food dehydrating device skewer 120 be in a diagonal position across the food dehydrating device endless cable 80 to permit even dehydration of the food item.

From the above description of the invention, those skilled in the art will perceive improvements, changes and modifications. Such improvements, changes and modifications within the skill of the art are intended to be covered by the appended claims.

What is claimed is:

1. A food dehydrating device comprises:
a food dehydrating device box structure;
said food dehydrating device box structure having a food dehydrating device top region;
a food dehydrating device first side piece connected with said food dehydrating device top region;
a food dehydrating device bottom region connected with said food dehydrating device first side piece;
a food dehydrating device second side piece connected with said food dehydrating device top region and connected with said food dehydrating device bottom region;
a food dehydrating device rear screened section connected with said food dehydrating device top region;
a food dehydrating device endless cable first opening located in said food dehydrating device first side piece;
a food dehydrating device endless cable second opening located in said food dehydrating device first side piece; and,
a food dehydrating device endless cable extending through said food dehydrating device endless cable first opening and said food dehydrating device endless cable second opening.

2. The food dehydrating device according to claim 1, having a food dehydrating device front screened section connected with said food dehydrating device top region.

3. The food dehydrating device according to claim 2, wherein a food dehydrating device hinge connects said food dehydrating device front screened section to said food dehydrating device top region.

4. The food dehydrating device according to claim 1, wherein said food dehydrating device rear screened section is fixedly connected to said food dehydrating device bottom region.

5. The food dehydrating device according to claim 1, wherein a food dehydrating device endless cable extension extends from said food dehydrating device endless cable.

6. The food dehydrating device according to claim 5, wherein a food dehydrating device endless cable attachment is attached to said food dehydrating device endless cable extension.

7. The food dehydrating device according to claim 6, wherein a food dehydrating device endless cable extension securing mechanism is located on said food dehydrating device first side piece, and for when in use, said food dehydrating device endless cable extension securing mechanism secures said dehydrating device endless cable attachment to said food dehydrating device first side piece.

8. The food dehydrating device according to claim 1, wherein a plurality of legs depends from said food dehydrating device bottom region.

9. The food dehydrating device according to claim 8, wherein one or more of said plurality of legs comprises a food dehydrating device first lower leg and a food dehydrating device first upper leg.

10. The food dehydrating device according to claim 8, wherein one or more of said plurality of legs comprises a food dehydrating device first lower leg that at least partially telescope into said food dehydrating device first upper leg.

11. The food dehydrating device according to claim 10, wherein a plurality of openings are located in said dehydrating device first lower leg and said food dehydrating device first upper leg.

12. A food dehydrating device comprises:
a food dehydrating device box structure;
said food dehydrating device box structure having a food dehydrating device top region;
a food dehydrating device first side piece connected with said food dehydrating device top region;
a food dehydrating device bottom region connected with said food dehydrating device first side piece;
a food dehydrating device second side piece connected with said food dehydrating device bottom region and connected with said food dehydrating device top region;
a food dehydrating device rear screened section connected with said food dehydrating device top region;
a food dehydrating device front screened section connected with said food dehydrating device top region;
a food dehydrating device endless cable first opening located in said food dehydrating device first side piece;
a food dehydrating device endless cable first opening located in said food dehydrating device second side piece;
a food dehydrating device endless cable second opening located in said food dehydrating device first side piece;
a food dehydrating device endless cable opening located in said food dehydrating device second side piece;
a food dehydrating device endless cable extending through said food dehydrating device endless cable first openings, and said food dehydrating device endless cable second openings;
a food dehydrating device endless cable extension extending from said food dehydrating device endless cable;
a food dehydrating device endless cable attachment attached to said food dehydrating device endless cable extension; and,
a food dehydrating device endless cable extension securing mechanism 88 located on said food dehydrating device first side piece, and for when in use, said food dehydrating device endless cable extension securing mechanism secures said dehydrating device endless cable attachment to said food dehydrating device first side piece.

13. The food dehydrating device according to claim 12, wherein a food dehydrating device hinge connects said food dehydrating device front screened section to said food dehydrating device top region.

14. The food dehydrating device according to claim 12, wherein said food dehydrating device rear screened section is fixedly connected to said food dehydrating device bottom region.

15. The food dehydrating device according to claim 12, wherein a plurality of legs depend from said food dehydrating device bottom region.

16. The food dehydrating device according to claim 15, wherein one or more of said plurality of legs comprises a food dehydrating device first lower leg and a food dehydrating device first upper leg.

17. The food dehydrating device according to claim 15, wherein one or more of said plurality of legs comprises a food dehydrating device first lower leg that at least partially telescopes into said food dehydrating device first upper leg.

18. The food dehydrating device according to claim 15, wherein a plurality of openings are located in said dehydrating device first lower leg and said food dehydrating device first upper leg.
